(19) United States
(12) Patent Application Publication
(10) Pub. No.: US 2019/0375424 A1
(43) Pub. Date: Dec. 12, 2019

(54) STEERING AND SUSPENSION COMPONENT MONITORING SYSTEM FOR A VEHICLE

(71) Applicant: GM GLOBAL TECHNOLOGY OPERATIONS LLC, Detroit, MI (US)

(72) Inventors: Steven Aiuto, Commerce Twp., MI (US); Alexander M. Allan, Howell, MI (US)

(21) Appl. No.: 16/005,818

(22) Filed: Jun. 12, 2018

(51) Int. Cl. B60W 50/04; B60W 10/22; B60W 10/20; B60W 40/114; B60W 40/105; B60W 30/02; B60W 40/107; B60W 40/109

(52) U.S. Cl. CPC B60W 50/045; B60W 10/22; B60W 10/20; B60W 40/114; B60W 2520/14; B60W 30/02; B60W 40/107; B60W 40/109; B60W 40/105

(57) ABSTRACT

A system for monitoring at least one of a suspension component and a steering system in a vehicle includes a yaw rate module operable to determine a yaw rate of the vehicle, a yaw rate comparison module operable to compare the yaw rate with a reference yaw rate to determine a yaw rate error, and a vehicle control module operable to establish a vehicle capability rating based on the yaw rate error. The vehicle control module establishing one or more vehicle control parameters based on the vehicle capability rating.

### INTRODUCTION

The subject disclosure relates to the art of vehicles and, more particularly to a steering and suspension component monitoring system for a vehicle.

Motor vehicles include various components that contribute to stability and steering trueness. Over time, components may wear. Bushings may lose stiffness, springs may lose resiliency, linkages may shift or otherwise change configuration. All of the above may contribute to changes in wheel and/or chassis alignment. Human drivers often notice these changes and adjust their driving habits. A driver may adjust how the steering wheel is held, a speed at which certain maneuvers are made, or make other adjustments to accommodate changes that may occur, over time, in steering and/or suspension components.

While human operators may readily adjust to steering and/or suspension component changes, autonomous vehicles do not have the same instincts and controls. Controls for autonomous vehicles may be tuned to particular vehicle settings or a range of parameters. Thus, an autonomous vehicle may have difficulty accounting for changes that exceed certain thresholds. Further, an autonomous vehicle is not programed to notice subtle changes in vehicle handling that may indicate the need for maintenance. Accordingly, it is desirable to provide a vehicle with a system for detecting changes in steering and suspension components.

### SUMMARY

In one exemplary embodiment, a system for monitoring at least one of a suspension component and a steering system in a vehicle includes a yaw rate module operable to determine a yaw rate of the vehicle, a yaw rate comparison module operable to compare the yaw rate with a reference yaw rate to determine a yaw rate error, and a vehicle control module operable to establish a vehicle capability rating based on the yaw rate error. The vehicle control module establishing one or more vehicle control parameters based on the vehicle capability rating.

In addition to one or more of the features described herein an inertia measurement unit (IMU) is operatively connected to the yaw rate module, the IMU being operable to detect vehicle longitudinal acceleration, vehicle lateral acceleration, and vehicle yaw rate.

In addition to one or more of the features described herein a steered wheel angle sensor is operable to determine an angle of a steered wheels on the vehicle, the steered wheel angle sensor being operatively connected to the yaw rate module.

In addition to one or more of the features described herein a velocity sensor is operable to determine a velocity of the vehicle, the velocity sensor being operatively connected to the yaw rate module.

In addition to one or more of the features described herein a friction module is operable to determine a frictional coefficient of one or more vehicle tires, the friction module being operatively connected to the yaw rate module.

Also disclosed is a method of operating a vehicle including determining a vehicle yaw rate, comparing the vehicle yaw rate with a reference yaw rate to determine a yaw rate error, establishing a vehicle capability rating based on the yaw rate error, and controlling the vehicle based on the vehicle capability rating.

In addition to one or more of the features described herein include identifying a component failure based on the yaw rate error.

In addition to one or more of the features described herein determining the yaw rate error includes calculating an accumulated yaw rate error for the vehicle.

In addition to one or more of the features described herein establishing the vehicle capability rating includes determining one or more vehicle capability thresholds.

In addition to one or more of the features described herein include signaling a need for vehicle repair if the vehicle capability rating is below a selected vehicle capability threshold.

In addition to one or more of the features described herein controlling the vehicle includes adjusting a vehicle path based on the vehicle capability rating.

In addition to one or more of the features described herein controlling the vehicle includes adjusting a control algorithm for the vehicle.

In addition to one or more of the features described herein controlling the vehicle includes controlling an autonomous vehicle.

Further disclosed is a vehicle including a body, a steering system, one or more suspension components, and a system for monitoring at least one of the one or more suspension components and the steering system including a yaw rate module operable to determine a yaw rate of the vehicle, a yaw rate comparison module operable to compare the yaw rate with a reference yaw rate to determine a yaw rate error, and a vehicle control module operable to establish a vehicle capability rating based on the yaw rate error. The vehicle control module establishes one or more vehicle control parameters based on the vehicle capability rating.

In addition to one or more of the features described herein an inertia measurement unit (IMU) is operatively connected to the yaw rate module, the IMU being operable to detect vehicle longitudinal acceleration, vehicle lateral acceleration, and vehicle yaw rate.

In addition to one or more of the features described herein a steered wheel angle sensor is operable to determine an angle of a steered wheel of the vehicle, the steered wheel angle sensor being operatively connected to the yaw rate module.

In addition to one or more of the features described herein a velocity sensor is operable to determine a velocity of the vehicle, the velocity sensor being operatively connected to the yaw rate module.

In addition to one or more of the features described herein a friction module is operable to determine a frictional coefficient of one or more vehicle tires, the friction module being operatively connected to the yaw rate module.

In addition to one or more of the features described herein the vehicle comprises an autonomous vehicle.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 depicts a vehicle including a suspension and steering component monitoring system, in accordance with an aspect of an exemplary embodiment; and

FIG. 2 is a block diagram depicting the suspension and steering component monitoring system, in accordance with an aspect of an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

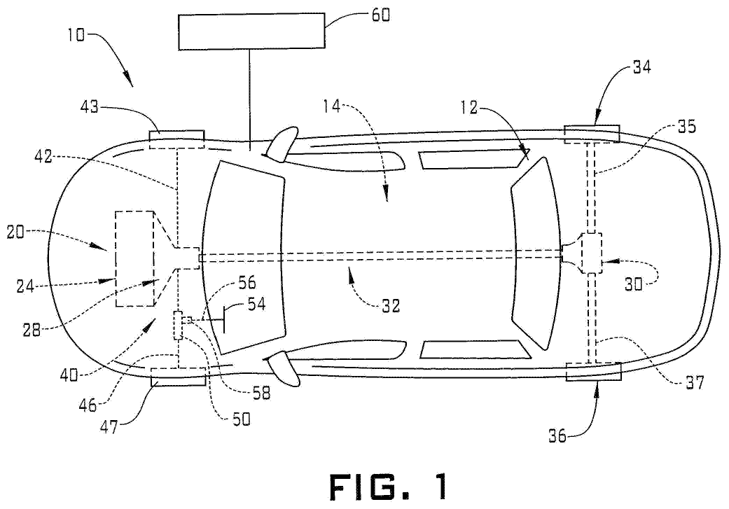

A vehicle, in accordance with an exemplary embodiment, is indicted generally at 10 in FIG. 1. Vehicle 10 includes a body or chassis 12 that defines, at least in part, an occupant compartment 14. A prime mover 20 is arranged in chassis 12. Prime mover 20 may take the form of an engine or motor 24. Engine or motor 24 may take on various forms including internal combustion engines, hybrid engines, electric motors, or variations thereof. Prime mover 20 is operatively connected to a transmission 28 which, in turn, is mechanically linked to a rear differential or rear drive module (RDM) 30 through a propshaft 32. RDM 30 transfers power from prime mover 20 to a first rear wheel 34 through a first axle 35 and to a second rear wheel 36 through a second axle 37.

It should be noted that while shown as a rear wheel drive system, exemplary embodiments also contemplate front wheel drive systems and all-wheel drive (AWD) systems. It should also be understood that the exemplary embodiments may be incorporated into a wide array of vehicles including two-wheeled vehicles, three-wheeled vehicles, and vehicles having more than four wheels.

Vehicle 10 also includes a steering system 40 having a first linkage 42 coupled to a first front wheel 43 and a second linkage 46 coupled to a second front wheel 47. First front wheel 43 and second front wheel 47 represent steered wheels. First and second linkages 42 and 46 are connected to a steering box 50 that may be coupled to a steering wheel 54 through a shaft 56. Steering box 50 may receive inputs from steering wheel 54 or through a vehicle control system 58 to establish a desired vehicle path. It should be understood that steering system 40 may take on various forms and could include systems that do not rely in inputs through a steering wheel, or systems that do not employ conventional steering linkages.

Vehicle control system 58 may be controlled by a computer (not shown) such that vehicle 10 may define an autonomous vehicle. Steering system 40 includes various components, in addition to those described that may, over time, become worn. Similarly, chassis components such as springs, bushings and the like may become worn. Worn steering system, chassis, and/or other components may affect vehicle alignment that could negatively impact vehicle tracking and handling.

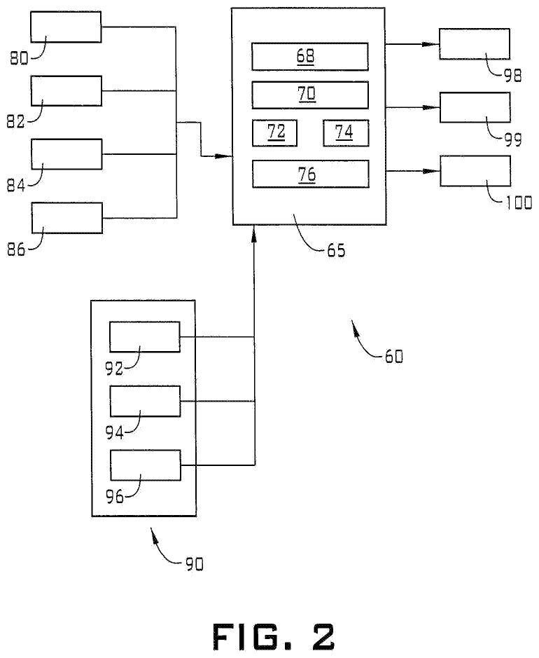

In accordance with an exemplary embodiment, vehicle 10 includes a monitoring system 60 that monitors for worn steering and/or chassis components that may affect steering alignment and/or handling. Referring to FIG. 2, monitoring system 60 includes a monitoring module 65 having a central processor unit (CPU) or graphics processor unit (GPU) 68 and a non-volatile memory 70. As will be detailed herein, monitoring module 65 may also include a yaw rate module 72, a yaw rate comparison module 74, and a vehicle control module 76. At this point, it should be understood that while shown as being incorporated into a single monitoring module 65, CPU 68, memory 70, yaw rate module 72, yaw rate comparison module 74, and vehicle control module 76 may not be co-located. Further, it should be understood that while shown as separate modules, yaw rate module 72, yaw rate comparison module 74, and vehicle control module 76 may be integrated into one or more modules that could be incorporated into various vehicle systems.

In further accordance with an exemplary embodiment, monitoring module 65 may receive inputs from an inertia measurement unit (IMU) 80. IMU 80 may detect and send vehicle longitudinal acceleration data, vehicle lateral acceleration data and/or vehicle yaw data to monitoring module 65. Monitoring module 65 may also receive inputs from a steered wheel angle sensor 82, a vehicle velocity sensor 84, and a surface Mu or friction module 86 that may receive signals from various vehicle sensors to determine and/or estimate an amount of friction that may exist between one or more of wheels 34, 36, 43, and 47 and a road surface.

Steered wheel angle sensor 82 may be incorporated into steering wheel 54 or may form part of an electric power steering (EPS) system (not shown). Further, steered wheel angle sensor 82 should be understood to detect and/or calculate an angle of, for example, wheels that provide directional changes to vehicle 10. In the example, shown steered wheel angle sensor 82 detects and/or determines an angle of first and second front wheels 43 and 47 relative to a longitudinal axis of chassis 12.

Monitoring module 65 may also contain baseline reference values 90 that are associated with a particular vehicle model. Baseline reference values 90 may include IMU ranges 92 for vehicle longitudinal acceleration, vehicle lateral acceleration, and reference yaw rate, steered wheel angle ranges 94 and velocity ranges 96. Baseline reference values 90 may be stored in non-volatile memory 70 and may be replaced and/or updated as necessary. As will be detailed herein, monitoring module 65 may output an accumulated yaw rate error 98, a component service alert 99, and/or exercise control over vehicle 10 based on detected steering and or component wear. It should be understood that accumulated yaw rate error represents a summing of a difference between actual or measured (calculated) yaw rate data and baseline or modeled yaw rate data.

In an embodiment, monitoring module 65 receives data from one or more of IMU 80, steered wheel angle sensor 82, velocity sensor 84 and surface Mu module 86. The data is passed to yaw rate module 72 which determines an actual yaw rate of the vehicle. The vehicle yaw rate may be passed to yaw rate comparison module 74. Yaw rate comparison module 74 may compare the yaw rate to one or more of baseline or reference values 90. Over time, an accumulated yaw rate error is collected. If the accumulated yaw rate error exceeds one or more of baseline reference values 90, vehicle control module 76 may adjust vehicle control parameters for vehicle 10. Further, monitoring module 65 may employ the accumulated yaw rate error to determine whether there exists a steering and/or chassis component failure, degradation or otherwise benefit from service.

In accordance with an exemplary aspect, the accumulated yaw rate error may be exported from monitoring module 65 to an on-board computer and/or passed to a remote system through, for example, accumulated yaw rate output 98. Likewise, if monitoring module 65 determines that a steering and/or chassis component may need service, an alert may be passed to the on-board computer or remote system through, for example, component service output 99. Further, if the accumulated yaw rate error exceeds one or more baseline value 90, vehicle control module 76 may establish a degraded capability rating 100 for vehicle 10.

In accordance with an exemplary aspect, vehicle control module 76 may establish the degraded capability rating 100 as a percentage of normal or base line vehicle capability thresholds. The degraded capability rating 100 may establish one or more control thresholds for an autonomous driving module (not shown). The autonomous driving module may adjust path planning for vehicle 10 based on degraded capability rating 100. For example, vehicle control module 76 may output to an autonomous driving module a steering wheel angle that may accommodate a detected alignment issue. In another example, vehicle control module 76 may limit vehicle speed in certain road conditions to accommodate worn chassis components. Thus, it should be understood that monitoring module 65 detects changes in steering and/or chassis components and may signal vehicle control module 76 to adjust vehicle operation based on those changes. Further, the monitoring module may provide a service output that a steering component, a chassis component or both may need inspection and/or maintenance.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A system for monitoring at least one of a suspension component and a steering system in a vehicle comprising:
a yaw rate module operable to determine a yaw rate of the vehicle;
a yaw rate comparison module operable to compare the yaw rate with a reference yaw rate to determine a yaw rate error; and
a vehicle control module operable to establish a vehicle capability rating based on the yaw rate error, the vehicle control module establishing one or more vehicle control parameters based on the vehicle capability rating.

2. The system of claim 1, further comprising: an inertia measurement unit (IMU) operatively connected to the yaw rate module, the IMU being operable to detect vehicle longitudinal acceleration, vehicle lateral acceleration, and vehicle yaw rate.

3. The system of claim 1, further comprising: a steered wheel angle sensor operable to determine an angle of a steered wheels on the vehicle, the steered wheel angle sensor being operatively connected to the yaw rate module.

4. The system of claim 1, further comprising: a velocity sensor operable to determine a velocity of the vehicle, the velocity sensor being operatively connected to the yaw rate module.

5. The system of claim 1, further comprising: a friction module operable to determine a frictional coefficient of one or more vehicle tires, the friction module being operatively connected to the yaw rate module.

6. A method of operating a vehicle comprising:
determining a vehicle yaw rate;
comparing the vehicle yaw rate with a reference yaw rate to determine a yaw rate error;
establishing a vehicle capability rating based on the yaw rate error; and
controlling the vehicle based on the vehicle capability rating.

7. The method of claim 6, further comprising: identifying a component failure based on the yaw rate error.

8. The method of claim 6, wherein determining the yaw rate error includes calculating an accumulated yaw rate error for the vehicle.

9. The method of claim 6, wherein establishing the vehicle capability rating includes determining one or more vehicle capability thresholds.

10. The method of claim 9, further comprising: signaling a need for vehicle repair if the vehicle capability rating is below a selected vehicle capability threshold.

11. The method of claim 6, wherein controlling the vehicle includes adjusting a vehicle path based on the vehicle capability rating.

12. The method of claim 6, wherein controlling the vehicle includes adjusting a control algorithm for the vehicle.

13. The method of claim 6, wherein controlling the vehicle includes controlling an autonomous vehicle.

14. A vehicle comprising:
a body;
a steering system;
one or more suspension components; and
a system for monitoring at least one of the one or more suspension components and the steering system comprising:
a yaw rate module operable to determine a yaw rate of the vehicle;
a yaw rate comparison module to operably to compare the yaw rate with a reference yaw rate to determine a yaw rate error; and
a vehicle control module operable to establish a vehicle capability rating based on the yaw rate error, the vehicle control module establishing one or more vehicle control parameters based on the vehicle capability rating.

15. The vehicle of claim 14, further comprising: an inertia measurement unit (IMU) operatively connected to the yaw rate module, the IMU being operable to detect vehicle longitudinal acceleration, vehicle lateral acceleration, and vehicle yaw rate.

16. The vehicle of claim 14, further comprising: a steered wheel angle sensor operable to determine an angle of a steered wheel of the vehicle, the steered wheel angle sensor being operatively connected to the yaw rate module.

17. The vehicle of claim 14, further comprising: a velocity sensor operable to determine a velocity of the vehicle, the velocity sensor being operatively connected to the yaw rate module.

18. The vehicle of claim 14, further comprising: a friction module operable to determine a frictional coefficient of one or more vehicle tires, the friction module being operatively connected to the yaw rate module.

19. The vehicle according to claim 14, wherein the vehicle comprises an autonomous vehicle.
